(19) United States
(12) Patent Application Publication
(10) Pub. No.: US 2026/0142957 A1
(43) Pub. Date: May 21, 2026

(54) METHOD AND APPARATUS FOR AUTHENTICATION

(71) Applicant: Telefonaktiebolaget LM Ericsson(publ), Stockholm (SE)

(72) Inventor: Hongxia LONG, Shanghai (CN)

(73) Assignee: Telefonaktiebolaget LM Ericsson(publ), Stockholm (SE)

(21) Appl. No.: 19/121,449

(22) PCT Filed: Oct. 17, 2023
(86) PCT No.: PCT/CN2023/124885

§ 371 Date: Apr. 16, 2025

(30) Foreign Application Priority Data
Oct. 21, 2022 (WO) PCT/CN2022/126714

(51) Int. Cl. H04L 9/40

(52) U.S. Cl. CPC H04L 63/08; H04L 63/06

(57) ABSTRACT

Embodiments of the present disclosure provide method and apparatus for authentication. A method performed by an authentication service node comprises receiving a first authentication request sent by an access and mobility node. The first authentication request comprises a subscription concealed identifier and first information indicating whether a primary authentication is for a terminal device onboarding. The method further comprises processing the first authentication request based on the first information.

### TECHNICAL FIELD

The non-limiting and exemplary embodiments of the present disclosure generally relate to the technical field of communications, and specifically to methods and apparatuses for authentication.

### BACKGROUND

This section introduces aspects that may facilitate a better understanding of the disclosure. Accordingly, the statements of this section are to be read in this light and are not to be understood as admissions about what is in the prior art or what is not in the prior art.

The authentication and key agreement procedures may be supported in various networks. For example, in a communication network such as LTE (long term evolution) or NR (new radio) as defined by 3rd Generation Partnership Project (3GPP), it supports various authentication and key agreement procedures.

The purpose of the primary authentication and key agreement procedures may enable mutual authentication between a user equipment (UE) and the network and provide keying material that can be used between the UE and the serving network in subsequent security procedures.

Standalone non public network (SNPN) may support UE access using credentials owned by a Credentials Holder separate from the SNPN. Onboarding of UEs for SNPNs allows the UE to access an Onboarding Network (ONN) for the purpose of provisioning the UE with SNPN credentials for primary authentication and other information to enable access to a desired SNPN, i.e. (re-)select and (re-)register with SNPN.

FIG. 1 shows a flowchart of primary authentication with external domain, which is same as Figure I.2.2.2.2-1 of 3GPP TS 33.501 V17.7.0, the disclosure of which is incorporated by reference herein in its entirety.

The procedures enables UEs to access an SNPN which makes use of a credential management system managed by a credential provider external to the SNPN.

In this scenario the authentication server role is taken by the AAA (authentication, authorization and accounting) Server. The AUSF (Authentication Service Function) acts as EAP (Extensible Authentication Protocol) authenticator and interacts with the AAA Server to execute the primary authentication procedure.

The architecture for SNPN access using credentials from a Credentials Holder using AAA Server is described in clause 5.30.2.9.2 of 3GPP TS 23.501 V17.5.0, the disclosure of which is incorporated by reference herein in its entirety.

Clause I.2.2.2.2 of 3GPP TS 33.501 V17.7.0 described the steps as following.

0. The UE shall be configured with credentials from the Credentials holder e.g. SUPI containing a network-specific identifier and credentials for the key-generating EAP-method used. As part of configuration of the credentials, the UE shall also be configured with an indication that the UE shall use MSK for the derivation of KAUSF after the success of the primary authentication. The exact procedures used to configure the UE are not specified in the present document.

It is further assumed that there exists a trust relation between the SNPN and the Credentials holder AAA Server. These entities need to be mutually authenticated, and the information transferred on the interface need to be confidentiality. integrity and replay protected. When the procedures of this clause are used for onboarding purposes. the onboarding specific adaptations includes: the ‘credentials’ used is ‘Default credentials’, the ‘SUPI’ used is ‘onboarding SUPI’, the ‘SUCI’ used is ‘onboarding SUCI’ respectively.

1. The UE shall select the SNPN and initiate UE registration in the SNPN.

For construction of the SUCI, existing methods in clause 6.12 can be used. Otherwise, if the EAP method supports SUPI privacy, the UE may send an anonymous value SUCI based on configuration.

2. The AMF within the SNPN shall initiate a primary authentication for the UE using a Nausf_UEAuthentication_Authenticate service operation with the AUSF. The AMF shall discover and select an AUSF based on criterions specified in TS 23.501 [2] clause 5.30.2.9.2.

3. In the case of onboarding, steps 3-5 are omitted. If steps 3-5 are not omitted, the AUSF shall initiate a Nudm_UEAuthentication_Get service operation. The AUSF shall discover and select a UDM based on criterions specified in TS 23.501 [2] clause 5.30.2.9.

NOTE 1: SUPI will be used instead of SUCI in the case of a re-authentication.

4. In case the UDM receives a SUCI, the UDM shall resolve the SUCI to the SUPI before checking the authentication method applicable for the SUPI. The UDM decides to run primary authentication with an external entity based on subscription data.

In case the UDM receives an anonymous SUCI, the UDM decides to run primary authentication with an external entity based the realm part of the SUPI in NAI format.

NOTE 1a: The UDM needs to be configured with a list of realms and the intended authentication server (external or internal)

In case the UDM receives an anonymous SUCI that does not contain the realm part, the UDM shall abort the procedure. Otherwise, the UDM authorizes the UE based on realm part of SUCI and send the anonymous SUPI and the indicator to the AUSF as described in step5.

The anonymous SUPI shall be a NAI format.

5. In case the UDM received a SUCI in previous steps, the UDM shall provide the AUSF with the SUPI or anonymous SUPI and shall indicate to the AUSF to run primary authentication with a AAA Server in an external Credentials holder.

When a Credentials Holder using AAA Server is used for primary authentication, the AUSF uses the MSK to derive KAUSF. It is strongly recommended that the same credentials that are used for authentication between UE and the 5G SNPN are not used for the authentication between the UE and a non-5G network, assuming that 5G SNPN and non-5G network are in different security domains.

NOTE 2: MSKs obtained from the non-5G network could be used to impersonate the 5G SNPN towards the UE.

6. Based on the indication from the UDM. the AUSF shall select an NSSAAF as defined in TS 23.501 [2] and initiate a Nnssaaf_AIWF_Authenticate service operation towards that NSSAAF as defined in clause 14.4.2.

7. The N4SSAAF shall select AAA Server based on the domain name corresponding to the realm part of the SUPI. The NSSAAF shall perform related protocol conversion and relay EAP messages to the AAA Server.

NOTE 3: The interface and protocol between NSSAAF and AAA is out of scope of the present document and existing AAA protocols such as RADIUS or Diameter can be used.

8. The UE and AAA Server shall perform mutual authentication. The AAA Server shall act as the EAP Server for the purpose of primary authentication. The EAP Identity received by the AAA Server in the EAP-Response/Identity message in step 7 may contain anonymised SUPI. In such cases, AAA Server uses the EAP-method specific EAP Identity request/response messages to obtain the UE identifier as part of the EAP authentication between the UE and the AAA Server.

9. After successful authentication, the MSK and the SUPI (i.e., the UE identifier that is used for the successful EAP authentication) shall be provided from the AAA Server to the NSSAAF.

10. The NSSAAF returns the MSK and the SUPI to the AUSF using the Nnssaaf_AIWF_Authenticate service operation response message. The SUPI received from the AAA shall be used when deriving 5G keys (e.g., KAMF) that requires SUPI as an input for the key derivation.

11-13. In case of onboarding or SUCI received in step 2 is not anonymous, steps 11-13 are omitted. Otherwise, the AUSF verifies that the SUPI corresponds to a valid subscription in the SNPN by informing the UDM about the authentication result for the received SUPI using a Nudm_UEAuthentication_ResultConfirmation service operation. The UDM stores the authentication state for the SUPI and if there is not a subscription corresponding to the SUPI, the UDM shall return an error.

If the verification of the SUPI is not successful, then the AUSF rejects the UE access to the SNPN.

NOTE 4: If the above failure happens, the error is no failed authentication but lacking subscription in the SNPN.

14. The AUSF shall use the most significant 256 bits of MSK as the KAUSF. The AUSF shall also derive KSEAF from the KAUSF as defined in Annex A.6.

15. The AUSF shall send the successful indication together with the SUPI of the UE to the AMF together with the resulting KSEAF.

16. The AMF shall send the EAP success in a NAS message.

17. The UE shall derive the KAUSF from MSK as described in step 11 according to the pre-configured indication as described in step 0.

3GPP TS 29.509 V17.7.0, the disclosure of which is incorporated by reference herein in its entirety, described the definition of type AuthenticationInfo as following.

TABLE 6.1.6.2.2-1
Definition of type AuthenticationInfo

| Attribute name | Data type | P | Cardinality | Description |
|---|---|---|---|---|
| supiOrSuci | SupiOrSuci | M | 1 | Contains the SUPI or SUCI of the UE. |
| servingNetworkName | ServingNetworkName | M | 1 | Contains the Serving Network Name. |
| resynchronizationInfo | ResynchronizationInfo | O | 0 . . . 1 | Contains RAND and AUTS; see 3GPP 33.501 [8] |
| | | | | clause 9.4. |
| pei | Pei | O | 0 . . . 1 | Permanent Equipment Identifier |
| traceData | TraceData | O | 0 . . . 1 | Contains TraceData provided by the UDM to the AMF |
| udmGroupId | NfGroupId | O | 0 . . . 1 | Identity of the UDM group serving the SUPI |
| routingIndicator | String | O | 0 . . . 1 | When present, it shall indicate the Routing |
| | | | | Indicator of the UE. |
| | | | | Pattern: ‘\hat{ }[0-9]{1, 4}$’ |
| cellCagInfo | array(CagId) | O | 1 . . . N | CAGList of the CAG cell. |
| n5gcInd | boolean | O | 0 . . . 1 | N5GC device indicator (see 3GPP TS 33.501 [8]) |
| | | | | When present, this IE shall be set as follows: |
| | | | | true: authentication is for a N5GC device; |
| | | | | false (default): authentication is not for |
| | | | | a N5GC device. |
| | | | | See NOTE |
| supportedFeatures | SupportedFeatures | C | 0 . . . 1 | This IE shall be present if at least one optional |
| | | | | feature defined in clause 6.1.9 is supported. |
| pvsInfo | array(ServerAddressingInfo) | O | 1 . . . N | FQDN(s) and/or IP address(es) of the SNPN UE |
| | | | | onboarding Provisioning Servers (PVS). |
| nswoInd | boolean | O | 0 . . . 1 | NSWO Indicator (see 3GPP TS 33.501 [8]) |
| disasterRoamingInd | boolean | O | 0 . . . 1 | Disaster Roaming Indicator (see |
| | | | | 3GPP TS 23.502 [3]). |
| | | | | When present, this IE shall be set as follows: |
| | | | | true: Disaster Roaming service is applied; |
| | | | | false (default): Disaster Roaming service is not |
| | | | | applied. |

NOTE:
The attribute n5gcInd is used for EAP-TLS, which is described in the informative annex O of 3GPP TS 33.501 [8] and is not mandatory to support.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

There are some problems of the existing solutions for authentication.

Problem 1: As described in step 3 of FIG. 1, in case of onboarding step 3-5 are skipped. The problem is that based on 3GPP TS 29.509 V17.7.0 (e.g., AuthenticationInfo), AUSF is not aware of whether the authentication is for onboarding from existing signaling. So AUSF may rely on itself to deduce whether the authentication is for onboarding or not. There would be a waste or increasing unnecessary signaling if AUSF wrongly or blindly to query UDM for authentication method selection.

Problem 2: As described in steps 11-13 of FIG. 1, it requires AUSF to verify that the SUPI (Subscription Permanent Identifier) corresponds to a valid subscription in the SNPN by informing the UDM about the authentication result for the received SUPI using Nudm_UEAuthentication_ResultConfirmation service operation. It also required that in case of onboarding steps 11-13 are omitted, but the problem is that based on 3GPP TS 29.509 V17.7.0 (e.g., AuthenticationInfo), AUSF is not aware of whether the authentication is for onboarding or not. There would be a waste or increasing unnecessary signaling if AUSF wrongly or blindly to inform UDM about the authentication result for the received SUPI using Nudm_UEAuthentication_ResultConfirmation service operation.

Problem 3: In existing 3GPP specification such as 3GPP TS 33.501 V17.7.0, AUSF informs UE about the authentication result independent of the result of the Nudm_UEAuthentication_ResultConfirmation service operation because the authentication result is always returned. The problem is that if the authentication is not for onboarding, whether to informing the UE about the successful authentication result has dependency on the subscription verification result from UDM.

As described in steps 11-13 of FIG. 1, if the verification of SUPI is not successful, the error is no failed authentication but lacking subscription in the SNPN, but based on 3GPP TS 29.509 V17.7.0, whether to inform the UE about authentication result is not depending on the subscription verification result from UDM. If the verification of the SUPI is not successful, then the AUSF still accepts the UE to access to the SNPN. In addition, there is no corresponding cause code to indicate that user SNPN access rejection is not for the cause of authentication as indeed authentication is succeeded but for the cause of lacking SNPN subscription, so subscriber does not know the real problem or it may be very time consuming for troubleshooting.

To overcome or mitigate at least one of above mentioned problems or other problems, the embodiments of the present disclosure propose an improved solution for authentication.

In an embodiment, to solve problem 1, AUSF interface is enhanced so that when an authentication request is required from AMF, AMF shall indicate to AUSF in the signaling whether this authentication is for onboarding or not. With the inventive step enabled, AUSF is aware of whether this authentication is for onboarding and based on this indication to decide whether to query UDM for authentication method selection, so unnecessary signaling to UDM is avoided if the authentication is for onboarding.

In an embodiment, to solve problem 2, AUSF interface is enhanced so that when an authentication request is required from AMF, AMF shall indicate to AUSF in the signaling whether this authentication is for onboarding or not. With the inventive step enabled, AUSF is aware of whether this authentication is for onboarding and based on this indication to decide whether to inform UDM about the authentication result for the received SUPI using Nudm_UEAuthentication_ResultConfirmation service operation, so unnecessary signaling to UDM is avoided if the authentication is for onboarding.

In an embodiment, to solve problem 3, when AUSF hands the authentication result, it will update the business logic handling based on if the authentication is for onboarding. If it is not for onboarding and the SUPI from step 2 of FIG. 1 is not anonymous, it will firstly inform UDM about the authentication result for the received SUPI using Nudm_UEAuthentication_ResultConfirmation service operation and wait for the result from UDM. If the result is OK, then AUSF informs AMF of the success authentication result, but if the result from UDM is failure then AUSF rejects the UE to access this SNPN even if the authentication result is success. AUSF interface is enhanced to indicate the cause of lacking SNPN subscription although authentication is a success, so when UE gets this indication, it can show the true cause of lack of SNPN subscription to the user and the user can contact the SNPN operator support to fix the problem.

In a first aspect of the disclosure, there is provided a method performed by an authentication service node. The method comprises receiving a first authentication request sent by an access and mobility node. The first authentication request comprises a subscription concealed identifier and first information indicating whether a primary authentication is for a terminal device onboarding. The method further comprises processing the first authentication request based on the first information.

In an embodiment, the first information is an indicator.

In an embodiment, when the indicator is set to true, it indicates that the primary authentication is for the terminal device onboarding.

In an embodiment, when the indicator is set to false or the indicator is not present, it indicates that the primary authentication is not for the terminal device onboarding.

In an embodiment, processing the first authentication request based on the first information comprises when the first information indicates that the primary authentication is for the terminal device onboarding, skipping a selection of a data management node and skipping sending a request for authentication method selection to the data management node and when the first information indicates that the primary authentication is not for the terminal device onboarding, selecting the data management node and sending the request for authentication method selection to the data management node.

In an embodiment, the method further comprises sending a second authenticate request to a standalone non public network (SNPN) authentication and authorization node. The method further comprises receiving a second authenticate response comprising an authentication success, a master session key and a subscription permanent identifier from the SNPN authentication and authorization node. The method further comprises when the first information indicates that the primary authentication is for the terminal device onboarding or the subscription concealed identifier received in the first authentication request is not anonymous, skipping sending an authentication result confirmation request to a data management node. The method further comprises when the first information indicates that the primary authentication is not for the terminal device onboarding and/or the subscription concealed identifier received in the first authentication request is anonymous, sending the authentication result confirmation request to the data management node and receiving an authentication result confirmation response from the data management node. The authentication result confirmation request is used for verifying that the subscription permanent identifier corresponds to a valid subscription in the SNPN.

In an embodiment, when the first information indicates that the primary authentication is for the terminal device onboarding or a subscription concealed identifier received in the first authentication request is not anonymous, the method further comprises generating a key of the authentication service node and a key of security anchor functionality. The method further comprises sending a first authentication response comprising the authentication success, the key of security anchor functionality and the subscription permanent identifier to the access and mobility node.

In an embodiment, when the first information indicates that the primary authentication is not for the terminal device onboarding and/or the subscription concealed identifier received in the first authentication request is anonymous, the method further comprises when the authentication result confirmation response comprises second information indicating that user subscription verification is failed or a user is not found or it lacks SNPN subscription, rejecting the terminal device to access the SNPN and sending a first authentication response comprising the second information to the access and mobility node.

In an embodiment, the SNPN authentication and authorization node comprises a network slice specific and SNPN authentication and authorization function (NSSAAF).

In an embodiment, the data management node comprises a unified data management (UDM).

In an embodiment, the access and mobility node comprises an access and mobility management function (AMF).

In an embodiment, the authentication service node comprises an authentication server function (AUSF).

In a second aspect of the disclosure, there is provided a method performed by an access and mobility node. The method comprises receiving a registration request for registering in a standalone non public network (SNPN) from a terminal device. The registration request comprises a subscription concealed identifier. The method further comprises sending a first authentication request to an authentication service node. The first authentication request comprises the subscription concealed identifier and first information indicating whether a primary authentication is for a terminal device onboarding.

In an embodiment, the first information is an indicator.

In an embodiment, when the indicator is set to true, it indicates that the primary authentication is for the terminal device onboarding.

In an embodiment, when the indicator is set to false or the indicator is not present, it indicates that the primary authentication is not for the terminal device onboarding.

In an embodiment, when the first information indicates that the primary authentication is for the terminal device onboarding or the subscription concealed identifier is not anonymous, the method further comprises receiving a first authentication response comprising an authentication success, a key of security anchor functionality and a subscription permanent identifier from the authentication service node. The method further comprises sending the authentication success to the terminal device.

In an embodiment, when the first information indicates that the primary authentication is not for the terminal device onboarding and/or the subscription concealed identifier is anonymous, the method further comprises receiving a first authentication response comprising the second information indicating that user subscription verification is failed or a user is not found or it lacks SNPN subscription from the authentication service node. The method further comprises sending the second information to the terminal device.

In an embodiment, the access and mobility node comprises an access and mobility management function (AMF).

In an embodiment, the authentication service node comprises an authentication server function (AUSF).

In a third aspect of the disclosure, there is provided a method performed by a terminal device. The method comprises sending a registration request for registering in a standalone non public network (SNPN) to an access and mobility node. The registration request comprises a subscription concealed identifier. The method further comprises receiving an authentication success or second information from the access and mobility node. The second information indicates that user subscription verification is failed or a user is not found or it lacks SNPN subscription.

In an embodiment, the access and mobility node comprises an access and mobility management function (AMF).

In an embodiment, the method further comprises providing the second information to a user of the terminal device.

In a fourth aspect of the disclosure, there is provided an authentication service node. The authentication service node comprises a processor and a memory coupled to the processor. Said memory contains instructions executable by said processor. Said authentication service node is operative to receive a first authentication request sent by an access and mobility node. The first authentication request comprises a subscription concealed identifier and first information indicating whether a primary authentication is for a terminal device onboarding. Said authentication service node is further operative to process the first authentication request based on the first information.

In a fifth aspect of the disclosure, there is provided an access and mobility node. The access and mobility node comprises a processor and a memory coupled to the processor. Said memory contains instructions executable by said processor. Said access and mobility node is operative to receive a registration request for registering in a standalone non public network (SNPN) from a terminal device. The registration request comprises a subscription concealed identifier. Said access and mobility node is further operative to send a first authentication request to an authentication service node. The first authentication request comprises the subscription concealed identifier and first information indicating whether a primary authentication is for a terminal device onboarding.

In a sixth aspect of the disclosure, there is provided a terminal device. The terminal device comprises a processor and a memory coupled to the processor. Said memory contains instructions executable by said processor. Said terminal device is operative to send a registration request for registering in a standalone non public network (SNPN) to an access and mobility node. The registration request comprises a subscription concealed identifier. Said terminal device is further operative to receive an authentication success or second information from the access and mobility node. The second information indicates that user subscription verification is failed or a user is not found or it lacks SNPN subscription.

In another aspect of the disclosure, there is provided an authentication service node. The authentication service node comprises a first receiving module configured to receive a first authentication request sent by an access and mobility node. The first authentication request comprises a subscription concealed identifier and first information indicating whether a primary authentication is for a terminal device onboarding. The authentication service node further comprises a processing module configured to process the first authentication request based on the first information.

In an embodiment, the authentication service node further comprises a first sending module configured to send a second authenticate request to a standalone non public network (SNPN) authentication and authorization node.

In an embodiment, the authentication service node further comprises a second receiving module configured to receive a second authenticate response comprising an authentication success, a master session key and a subscription permanent identifier from the SNPN authentication and authorization node.

In an embodiment, the authentication service node further comprises a skipping module configured to, when the first information indicates that the primary authentication is for the terminal device onboarding or the subscription concealed identifier received in the first authentication request is not anonymous, skip sending an authentication result confirmation request to a data management node.

In an embodiment, when the first information indicates that the primary authentication is not for the terminal device onboarding and/or the subscription concealed identifier received in the first authentication request is anonymous, the authentication service node further comprises a second sending module configured to send the authentication result confirmation request to the data management node and a third receiving module configured to receive an authentication result confirmation response from the data management node. The authentication result confirmation request is used for verifying that the subscription permanent identifier corresponds to a valid subscription in the SNPN.

In an embodiment, when the first information indicates that the primary authentication is for the terminal device onboarding or a subscription concealed identifier received in the first authentication request is not anonymous, the authentication service node further comprises a generating module configured to generate a key of the authentication service node and a key of security anchor functionality and a third sending module configured to send a first authentication response comprising the authentication success, the key of security anchor functionality and the subscription permanent identifier to the access and mobility node.

In an embodiment, when the first information indicates that the primary authentication is not for the terminal device onboarding and/or the subscription concealed identifier received in the first authentication request is anonymous, and when the authentication result confirmation response comprises second information indicating that user subscription verification is failed or a user is not found or it lacks SNPN subscription, the authentication service node further comprises a rejecting module configured to reject the terminal device to access the SNPN and a fourth sending module configured to send a first authentication response comprising the second information to the access and mobility node.

In another aspect of the disclosure, there is provided an access and mobility node. The access and mobility node comprises a first receiving module configured to receive a registration request for registering in a standalone non public network (SNPN) from a terminal device. The registration request comprises a subscription concealed identifier. The access and mobility node further comprises a first sending module configured to send a first authentication request to an authentication service node. The first authentication request comprises the subscription concealed identifier and first information indicating whether a primary authentication is for a terminal device onboarding.

In an embodiment, when the first information indicates that the primary authentication is for the terminal device onboarding or the subscription concealed identifier is not anonymous, the access and mobility node further comprises a second receiving module configured to receive a first authentication response comprising an authentication success, a key of security anchor functionality and a subscription permanent identifier from the authentication service node and a second sending module configured to send the authentication success to the terminal device.

In an embodiment, when the first information indicates that the primary authentication is not for the terminal device onboarding and/or the subscription concealed identifier is anonymous, the access and mobility node further comprises a third receiving module configured to receive a first authentication response comprising the second information indicating that user subscription verification is failed or a user is not found or it lacks SNPN subscription from the authentication service node and a third sending module configured to send the second information to the terminal device.

In another aspect of the disclosure, there is provided a terminal device. The terminal device comprises a sending module configured to send a registration request for registering in a standalone non public network (SNPN) to an access and mobility node. The registration request comprises a subscription concealed identifier. The terminal device further comprises a receiving module configured to receive an authentication success or second information from the access and mobility node. The second information indicates that user subscription verification is failed or a user is not found or it lacks SNPN subscription.

In an embodiment, the terminal device further comprises a providing module configured to provide the second information to a user of the terminal device.

In another aspect of the disclosure, there is provided a computer program product comprising instructions which when executed by at least one processor, cause the at least one processor to perform the method according to any one of the first, second, or third aspects.

In another aspect of the disclosure, there is provided a computer-readable storage medium storing instructions which when executed by at least one processor, cause the at least one processor to perform the method according to any one of the first, second, or third aspects.

Embodiments herein may provide many advantages, of which a non-exhaustive list of examples follows. In some embodiments herein, unnecessary signaling to data management node such as UDM may be avoided if the authentication is for onboarding. This may improve the system performance of both authentication service node AUSF and data management node such as UDM. In some embodiments herein, onboarding service may be handled differently than non-onboarding service, so communications service provider (CSP) could monetize their network based on meeting different service requirements. In some embodiments herein, user satisfaction is improved as true cause for SNPN access rejection case could be detected, and user could find the corresponding support correctly. This could help CSP to reduce Operating Expense (OPEX) and at the same time retain subscriber royalty. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 shows a flowchart of primary authentication with external domain;

FIG. 2 schematically shows a 5G system architecture with access to SNPN using credentials from Credentials Holder using AAA Server;

FIG. 3 shows a flowchart of a method according to an embodiment of the present disclosure;

FIG. 4 shows a flowchart of a method according to another embodiment of the present disclosure;

FIG. 5 shows a flowchart of a method according to another embodiment of the present disclosure;

FIG. 6a shows a flowchart of a method according to another embodiment of the present disclosure;

FIG. 6b shows a flowchart of a method according to another embodiment of the present disclosure;

FIG. 6c shows a flowchart of a method according to another embodiment of the present disclosure;

FIG. 6d shows a flowchart of a method according to another embodiment of the present disclosure;

FIG. 6e shows a flowchart of a method according to another embodiment of the present disclosure;

FIG. 7a shows a flowchart of a method according to another embodiment of the present disclosure;

FIG. 7b shows a flowchart of primary authentication with UE onboarding indication according to another embodiment of the present disclosure;

FIG. 8a is a block diagram showing an apparatus suitable for practicing some embodiments of the disclosure;

FIG. 8b is a block diagram showing an authentication service node according to an embodiment of the disclosure;

FIG. 8c is a block diagram showing an access and mobility node according to an embodiment of the disclosure;

FIG. 9 is a block diagram showing a terminal device according to an embodiment of the disclosure;

FIG. 10 shows an example of a communication system according to an embodiment of the disclosure;

FIG. 11 is a block diagram of a host according to an embodiment of the disclosure; and

FIG. 12 shows a communication diagram of a host communicating via a network node with a UE over a partially wireless connection according to an embodiment of the disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G communication protocols, and/or any other protocols cither currently known or to be developed in the future.

The term “network device” or “network node” refers to any suitable network function (NF) which can be implemented in a network entity (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and Mobility Management Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc. For example, the 4G system (such as LTE (Long Term Evolution)) may include MME (Mobile Management Entity), HSS (home subscriber server), Policy and Charging Rules Function (PCRF), Packet Data Network Gateway (PGW), PGW control plane (PGW-C), Serving gateway (SGW), SGW control plane (SGW-C), E-UTRAN Node B (eNB), etc. In other embodiments, the network function may comprise different types of NFs for example depending on a specific network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

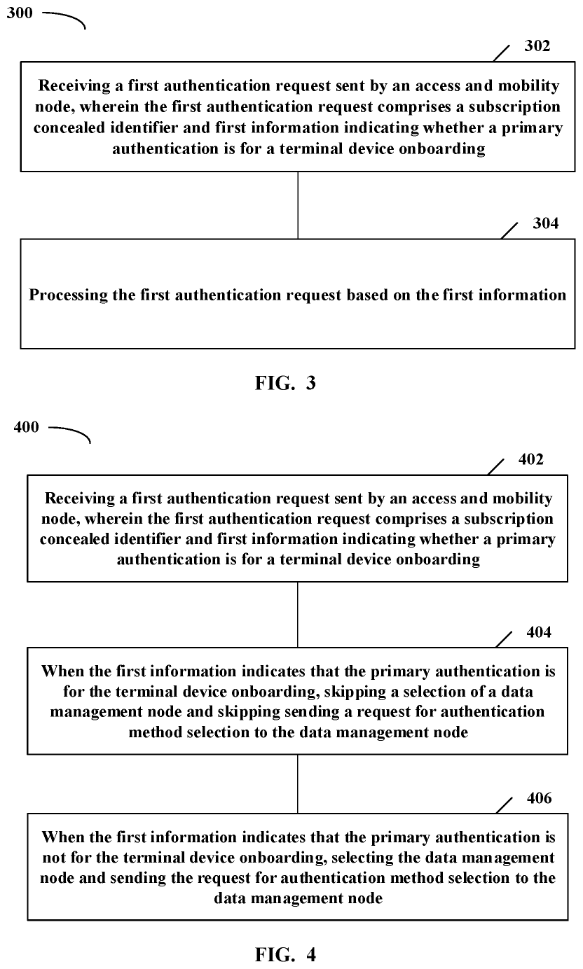

Although the subject matter described herein may be implemented in any appropriate type of system using any suitable components, the embodiments disclosed herein are described in relation to a communication system complied with the exemplary system architectures illustrated in FIG. 2. For simplicity, the system architecture of FIG. 2 only depicts some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

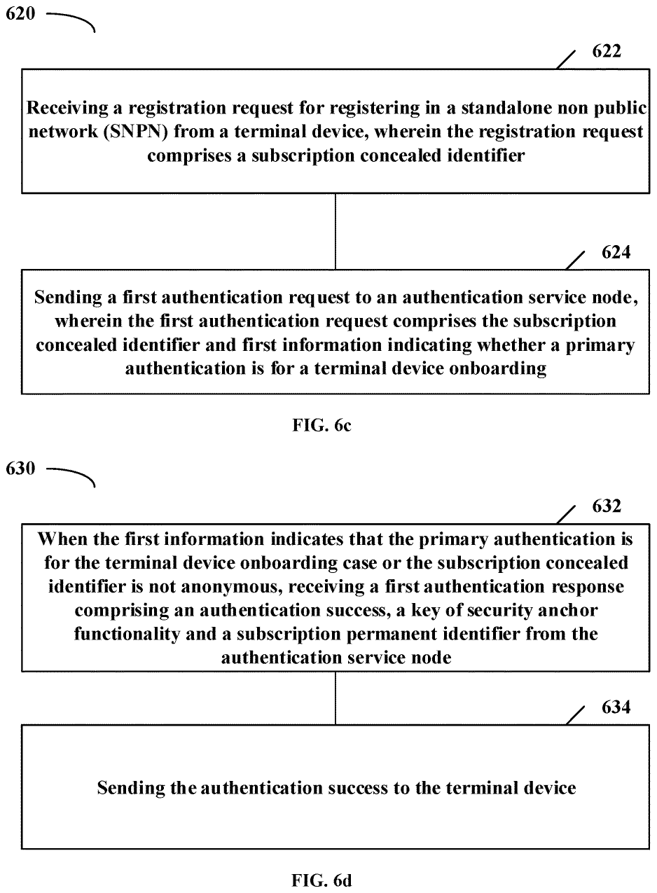

FIG. 2 schematically shows a 5G system architecture with access to SNPN using credentials from Credentials Holder using AAA Server, which is same as FIG. 5.30.2.9.2-1 as described in 3GPP TS 23.501 V17.5.0. The system architecture of FIG. 2 may comprise some exemplary elements such as AUSF, AMF, DN (data network), NEF, NRF, NSSF, PCF, SMF, UDM. UPF. AF, UE, (R)AN, NSSAAF (Network Slice-Specific Authentication and Authorization Function), NSACF (Network Slice Admission Control Function), AAA server, etc.

The AUSF and the UDM in SNPN may support primary authentication and authorization of UEs using credentials from a AAA Server in a Credentials Holder (CH).

If the UDM decides that the primary authentication is performed by AAA Server in CHI based on the UE's SUPI and subscription data. The Home Network Identifier, is derived by UDM from the SUCI (subscription concealed identifier) received from AUSF. The UDM then instructs the AUSF that primary authentication by a AAA Server in a CH is required, the AUSF shall discover and select the NSSAAF, and then forward FAP messages to the NSSAAF. The NSSAAF selects AAA Server based on the domain name corresponds to the realm part of the SUPI, relays EAP messages between AUSF and AAA Server (or AAA proxy) and performs related protocol conversion. The AAA Server acts as the EAP Server for the purpose of primary authentication.

The UDM in SNPN, based on SLA (Service Level Agreement) between Credentials Holder and SNPN, is pre-configured with information indicating whether the UE needs primary authentication from AAA Server.

The SUPI is used to identify the UE during primary authentication and authorization towards the AAA Server. SUPI privacy is achieved according to methods in clause 1.5 of 3GPP TS 33.501 V17.7.0.

The AMF discovers and selects the AUSF as described in clause 6.3.4 of 3GPP TS 23.501 V17.5.0 using the Home Network Identifier (realm part) and Routing Indicator present in the SUCI provided by a UE configured as described in clause 5.30.2.3 of 3GPP TS 23.501 V17.5.0.

The AMF and SMF shall retrieve the UE subscription data from UDM using SUPI.

The NSSAAF deployed in the SNPN can support primary authentication in the SNPN using credentials from Credentials Holder using a AAA Server (as depicted) and/or the NSSAAF can support Network Slice-Specific Authentication and Authorization with a Network Slice-Specific AAA Server (not depicted).

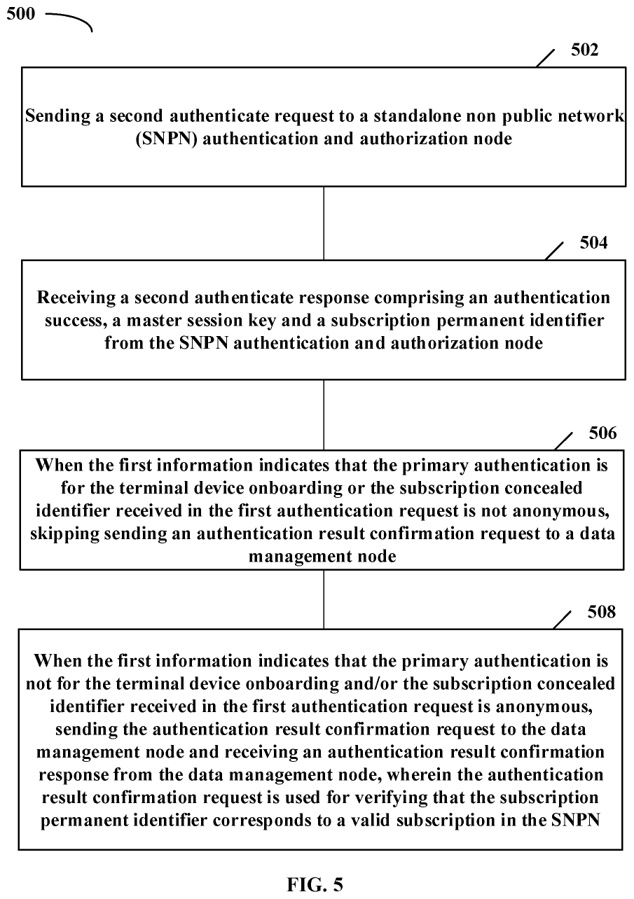

FIG. 3 shows a flowchart of a method according to an embodiment of the present disclosure, which may be performed by an apparatus implemented in or at or as an authentication service node or communicatively coupled to the authentication service node. As such, the apparatus may provide means or modules for accomplishing various parts of the method 300 as well as means or modules for accomplishing other processes in conjunction with other components.

At block 302, the authentication service node may receive a first authentication request sent by an access and mobility node. The first authentication request comprises a subscription concealed identifier and first information indicating whether a primary authentication is for a terminal device onboarding (case).

The authentication service node may be any suitable network device or node or entity or function. In an embodiment, the authentication service node may comprise an authentication server function (AUSF). In another embodiment, the authentication service node may comprise an Authentication Centre (AUC).

The access and mobility node may be any suitable network device or node or entity or function. In an embodiment, the access and mobility node may comprise an access and mobility management function (AMF). For example, the AMF may have Security Anchor Functionality (SEAF). In another embodiment, the access and mobility node may comprise a Mobile Management Entity n (MME).

The first authentication request may be any suitable message such as an existing message or a new message. In an embodiment, the first authentication request may be Nausf_UEAuthentication_Authenticate Request as described in 3GPP TS 33.501 V17.7.0.

The subscription concealed identifier may be any suitable subscription concealed identifier. In an embodiment, the subscription concealed identifier may be SUCI as described in 3GPP TS 33.501 V17.7.0. For example, the SUCI may be SUCI in NAI format (i.e., username@realm format as specified in clause 28.7.3 of 3GPP TS 23.003).

The first information indicating whether a primary authentication is for a terminal device onboarding may be any suitable information such as a bit, a flag, an indicator, etc. In an embodiment, the first information may be an indicator.

In an embodiment, when the indicator is set to true, it indicates that the primary authentication is for the terminal device onboarding.

In an embodiment, when the indicator is set to false or the indicator is not present, it indicates that the primary authentication is not for the terminal device onboarding.

At block 304, the authentication service node may process the first authentication request based on the first information. For example, when the primary authentication is not for the terminal device onboarding, the authentication service node may perform a corresponding operation. When the primary authentication is for the terminal device onboarding, the authentication service node may perform another corresponding operation.

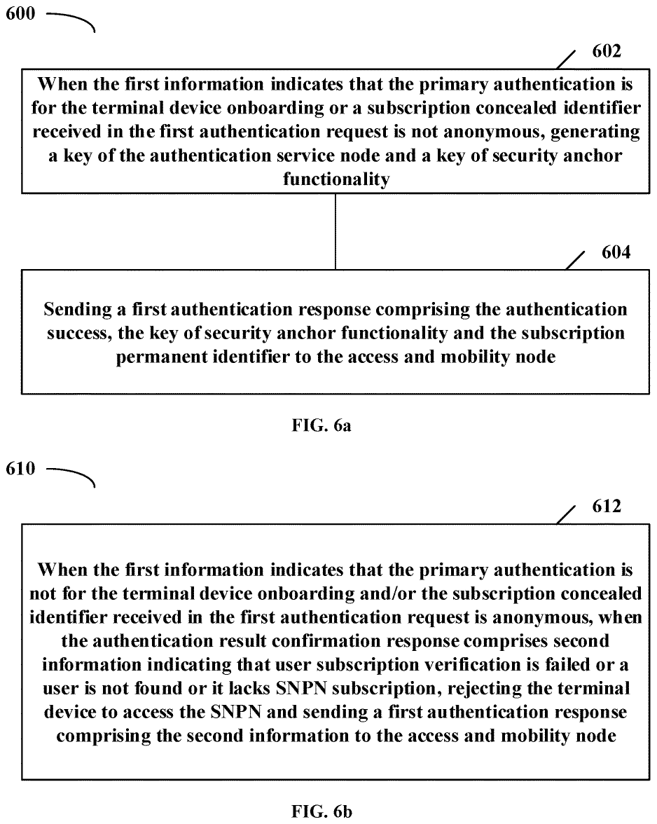

FIG. 4 shows a flowchart of a method according to another embodiment of the present disclosure, which may be performed by an apparatus implemented in or at or as an authentication service node or communicatively coupled to the authentication service node. As such, the apparatus may provide means or modules for accomplishing various parts of the method 400 as well as means or modules for accomplishing other processes in conjunction with other components. For some parts which have been described in the above embodiments, the description thereof is omitted here for brevity.

At block 402, the authentication service node may receive a first authentication request sent by an access and mobility node. The first authentication request comprises a subscription concealed identifier and first information indicating whether a primary authentication is for a terminal device onboarding.

At block 404, when the first information indicates that the primary authentication is for the terminal device onboarding, the authentication service node may skip a selection of a data management node and skip sending a request for authentication method selection to the data management node.

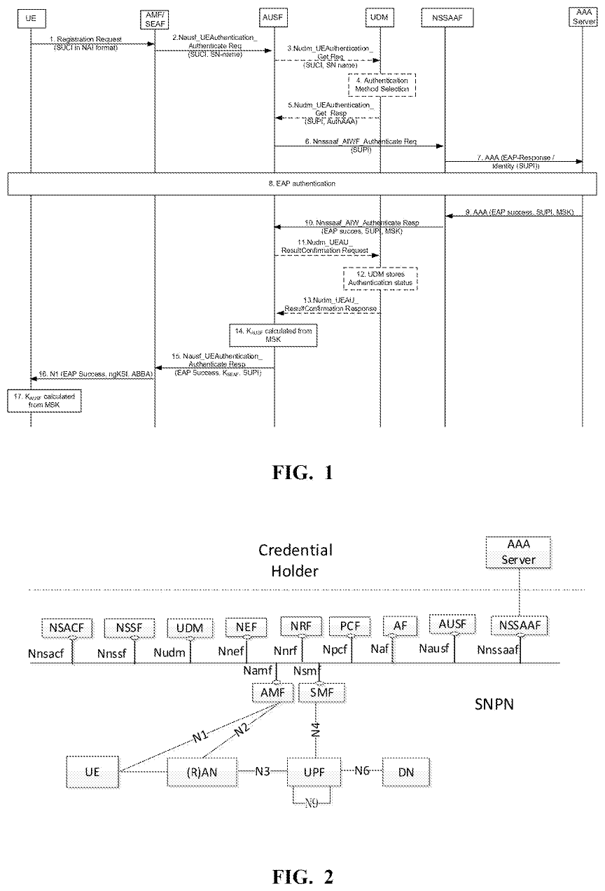

For example, when the first information indicates that the primary authentication is for the terminal device onboarding, steps 3-5 of FIG. 1 are omitted.

At block 406, when the first information indicates that the primary authentication is not for the terminal device onboarding, the authentication service node may select the data management node and send the request for authentication method selection to the data management node.

The data management node may be any suitable network device or node or entity or function. In an embodiment, the data management node may comprise a unified data management (UDM). In an embodiment, the data management node may comprise a home subscriber server (HSS) or a home location register (HLR).

For example, when the first information indicates that the primary authentication is not for the terminal device onboarding, steps 3-5 of FIG. 1 are performed.

FIG. 5 shows a flowchart of a method according to another embodiment of the present disclosure, which may be performed by an apparatus implemented in or at or as an authentication service node or communicatively coupled to the authentication service node. As such, the apparatus may provide means or modules for accomplishing various parts of the method 500 as well as means or modules for accomplishing other processes in conjunction with other components. For some parts which have been described in the above embodiments, the description thereof is omitted here for brevity.

At block 502, the authentication service node may send a second authenticate request to a standalone non public network (SNPN) authentication and authorization node.

The SNPN authentication and authorization node may be any suitable network device or node or entity or function. In an embodiment, the SNPN authentication and authorization node may comprise a network slice specific and SNPN authentication and authorization function (NSSAAF).

The second authenticate request may be any suitable message such as an existing message or a new message. In an embodiment, the second authenticate request may be Nnssaaf_AIW_Authenticate Request as described in 3GPP TS 33.501 V17.7.0.

In an embodiment, block 502 is same as step 6 of FIG. 1.

At block 504, the authentication service node may receive a second authenticate response comprising an authentication success, a master session key and a subscription permanent identifier from the SNPN authentication and authorization node.

The second authenticate response may be any suitable message such as an existing message or a new message. In an embodiment, the second authenticate response may be Nnssaaf_AIW_Authenticate Response as described in 3GPP TS 33.501 V17.7.0.

For example, when the NSSAAF receives the Nnssaaf_AIW_Authenticate Request from AUSF, steps 7-9 of FIG. 1 may be performed.

In an embodiment, block 504 is same as step 10 of FIG. 1.

At block 506, when the first information indicates that the primary authentication is for the terminal device onboarding or the subscription concealed identifier received in the first authentication request is not anonymous, the authentication service node may skip sending an authentication result confirmation request to a data management node.

The authentication result confirmation request may be any suitable message such as an existing message or a new message. In an embodiment, the authentication result confirmation request may be Nudm_UEAU_ResultConfirmation Request as described in 3GPP TS 33.501 V17.7.0.

At block 508, when the first information indicates that the primary authentication is not for the terminal device onboarding and/or the subscription concealed identifier received in the first authentication request is anonymous, the authentication service node may send the authentication result confirmation request to the data management node and receive an authentication result confirmation response from the data management node. The authentication result confirmation request is used for verifying that the subscription permanent identifier corresponds to a valid subscription in the SNPN.

For example, when the first information indicates that the primary authentication is not for the terminal device onboarding and/or the subscription concealed identifier received in the first authentication request is anonymous, steps 11-13 of FIG. 1 may be performed.

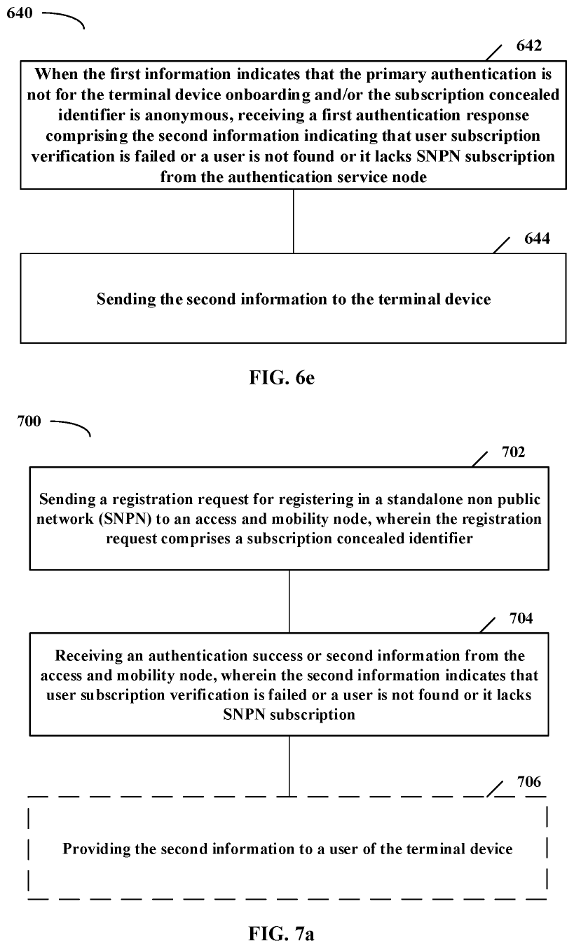

FIG. 6a shows a flowchart of a method according to another embodiment of the present disclosure, which may be performed by an apparatus implemented in or at or as an authentication service node or communicatively coupled to the authentication service node. As such, the apparatus may provide means or modules for accomplishing various parts of the method 600 as well as means or modules for accomplishing other processes in conjunction with other components. For some parts which have been described in the above embodiments, the description thereof is omitted here for brevity.

In this embodiment, the first information indicates that the primary authentication is for the terminal device onboarding or a subscription concealed identifier received in the first authentication request is not anonymous.

At block 602, the authentication service node may generate a key of the authentication service node and a key of security anchor functionality.

In an embodiment, block 602 is same as step 14 of FIG. 1.

At block 604, the authentication service node may send a first authentication response comprising the authentication success, the key of security anchor functionality and the subscription permanent identifier to the access and mobility node.

In an embodiment, block 604 is same as step 15 of FIG. 1.

FIG. 6b shows a flowchart of a method according to another embodiment of the present disclosure, which may be performed by an apparatus implemented in or at or as an authentication service node or communicatively coupled to the authentication service node. As such, the apparatus may provide means or modules for accomplishing various parts of the method 610 as well as means or modules for accomplishing other processes in conjunction with other components. For some parts which have been described in the above embodiments, the description thereof is omitted here for brevity.

In this embodiment, the first information indicates that the primary authentication is not for the terminal device onboarding and/or the subscription concealed identifier received in the first authentication request is anonymous.

At block 612, when the authentication result confirmation response comprises second information indicating that user subscription verification is failed or a user is not found or it lacks SNPN subscription, the authentication service node may reject the terminal device to access the SNPN and send a first authentication response comprising the second information to the access and mobility node.

FIG. 6c shows a flowchart of a method according to another embodiment of the present disclosure, which may be performed by an apparatus implemented in or at or as an access and mobility node or communicatively coupled to the access and mobility node. As such, the apparatus may provide means or modules for accomplishing various parts of the method 620 as well as means or modules for accomplishing other processes in conjunction with other components. For some parts which have been described in the above embodiments, the description thereof is omitted here for brevity.

At block 622, the access and mobility node may receive a registration request for registering in a standalone non public network (SNPN) from a terminal device. The registration request comprises a subscription concealed identifier.

In an embodiment, block 622 is same as step 1 of FIG. 1.

At block 624, the access and mobility node may send a first authentication request to an authentication service node. The first authentication request comprises the subscription concealed identifier and first information indicating whether a primary authentication is for a terminal device onboarding.

In an embodiment, the first information may be an indicator.

In an embodiment, when the indicator is set to true, it may indicate that the primary authentication is for the terminal device onboarding.

In an embodiment, when the indicator is set to false or the indicator is not present, it may indicate that the primary authentication is not for the terminal device onboarding.

In an embodiment, the access and mobility node comprises an access and mobility management function (AMF).

In an embodiment, the authentication service node comprises an authentication server function (AUSF).

FIG. 6d shows a flowchart of a method according to another embodiment of the present disclosure, which may be performed by an apparatus implemented in or at or as an access and mobility node or communicatively coupled to the access and mobility node. As such, the apparatus may provide means or modules for accomplishing various parts of the method 630 as well as means or modules for accomplishing other processes in conjunction with other components. For some parts which have been described in the above embodiments, the description thereof is omitted here for brevity.

In this embodiment, the first information indicates that the primary authentication is for the terminal device onboarding or the subscription concealed identifier is not anonymous.

At block 632, the access and mobility node may receive a first authentication response comprising an authentication success, a key of security anchor functionality and a subscription permanent identifier from the authentication service node.

In an embodiment, block 632 is same as step 15 of FIG. 1.

At block 634, the access and mobility node may send the authentication success to the terminal device.

In an embodiment, block 634 is same as step 16 of FIG. 1.

FIG. 6e shows a flowchart of a method according to another embodiment of the present disclosure, which may be performed by an apparatus implemented in or at or as an access and mobility node or communicatively coupled to the access and mobility node. As such, the apparatus may provide means or modules for accomplishing various parts of the method 640 as well as means or modules for accomplishing other processes in conjunction with other components. For some parts which have been described in the above embodiments, the description thereof is omitted here for brevity.

In this embodiment, the first information indicates that the primary authentication is not for the terminal device onboarding and/or the subscription concealed identifier is anonymous.

At block 642, the access and mobility node may receive a first authentication response comprising the second information indicating that user subscription verification is failed or a user is not found or it lacks SNPN subscription from the authentication service node.

At block 644, the access and mobility node may send the second information to the terminal device. For example, the second information may be sent in an NI message.

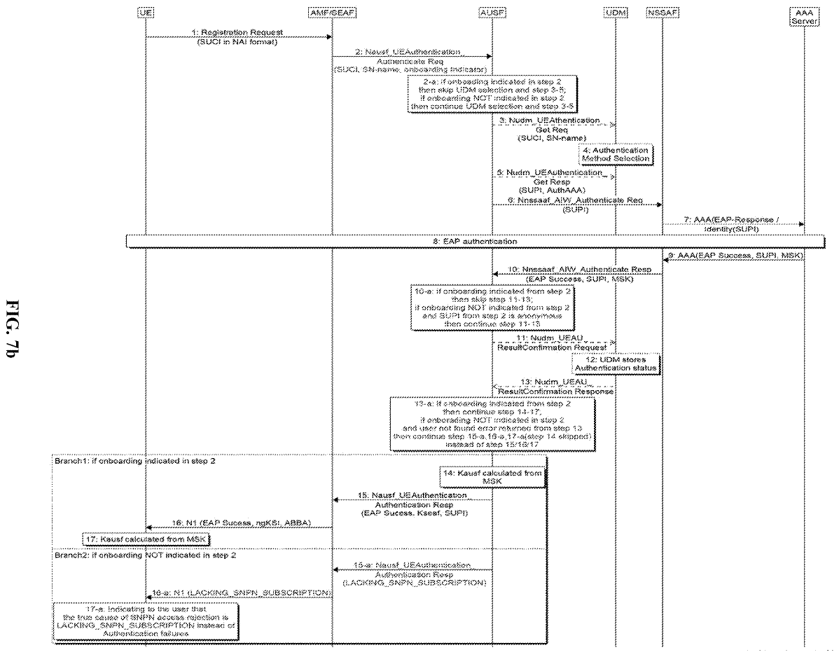

FIG. 7a shows a flowchart of a method according to another embodiment of the present disclosure, which may be performed by an apparatus implemented in or at or as a terminal device or communicatively coupled to the terminal device. As such, the apparatus may provide means or modules for accomplishing various parts of the method 700 as well as means or modules for accomplishing other processes in conjunction with other components. For some parts which have been described in the above embodiments, the description thereof is omitted here for brevity.

At block 702, the terminal device may send a registration request for registering in a standalone non public network (SNPN) to an access and mobility node. The registration request comprises a subscription concealed identifier.

In an embodiment, the access and mobility node may comprise an access and mobility management function (AMF).

At block 704, the terminal device may receive an authentication success or second information from the access and mobility node. The second information indicates that user subscription verification is failed or a user is not found or it lacks SNPN subscription.

At block 706, optionally, the terminal device may provide the second information to a user of the terminal device.

FIG. 7b shows a flowchart of primary authentication with UE onboarding indication according to another embodiment of the present disclosure.

The flowchart shows the changes for the primary authentication with UE onboarding indication in the signaling message from AMF to AUSF and how this information is further used by AUSF in the procedures for the primary authentication.

The changes compared to existing procedures of FIG. 1 are as below:

Step 2: The AMF within the SNPN shall initiate a primary authentication for the UE using a Nausf_UFAuthentication_Authenticate service operation with the AUSF. The AMF shall discover and select an AUSF based on criterions specified in 3GPP TS 23.501 V17.5.0 clause 5.30.2.9.2.

This step is updated that AMF shall indicate in the signaling to AUSF whether the primary authentication is for a UE boarding case with an onboarding indicator, if the indicator is set to true then it indicates to AUSF that the authentication is for an onboarding and if the indicator is set to false or this attribute is not present it implicitly means the authentication is not for an onboarding (case). AUSF shall store this value internally for future usage such as in step 10-a and step 13-a.

As described in 3GPP TS 29.509 V17.7.0, the Nausf_UEAuthentication_Authenticate service operation request payload can't support this possibility yet.

In an embodiment, Table 6.1.6.2.2-1 of 3GPP TS 29.509 V17.7.0 may be amended as following.

TABLE 6.1.6.2.2-1
Definition of type AuthenticationInfo

| Attribute name | Data type | P | Cardinality | Description |
|---|---|---|---|---|
| supiOrSuci | SupiOrSuci | M | 1 | Contains the SUPI or SUCI of the UE. |
| servingNetworkName | ServingNetworkName | M | 1 | Contains the Serving Network Name. |
| resynchronizationInfo | ResynchronizationInfo | O | 0 . . . 1 | Contains RAND and AUTS; see 3GPP 33.501 [8] |
| | | | | clause 9.4. |
| pei | Pei | O | 0 . . . 1 | Permanent Equipment Identifier |
| traceData | TraceData | O | 0 . . . 1 | Contains TraceData provided by the UDM to the AMF |
| udmGroupId | NfGroupId | O | 0 . . . 1 | Identity of the UDM group serving the SUPI |
| routingIndicator | String | O | 0 . . . 1 | When present, it shall indicate the Routing |
| | | | | Indicator of the UE. |
| | | | | Pattern: ‘\hat{ }[0-9]{1, 4}$’ |
| cellCagInfo | array(CagId) | O | 1 . . . N | CAGList of the CAG cell. |
| n5gcInd | boolean | O | 0 . . . 1 | N5GC device indicator (see 3GPP TS 33.501 [8]) |
| | | | | When present, this IE shall be set as follows: |
| | | | | true: authentication is for a N5GC device; |
| | | | | false (default): authentication is not for a N5GC |
| | | | | device. |
| | | | | See NOTE |
| supportedFeatures | SupportedFeatures | C | 0 . . . 1 | This IE shall be present if at least one optional |
| | | | | feature defined in clause 6.1.9 is supported. |
| pvsInfo | array(ServerAddressingInfo) | O | 1 . . . N | FQDN(s) and/or IP address(es) of the SNPN UE |
| | | | | onboarding Provisioning Servers (PVS). |
| nswoInd | boolean | O | 0 . . . 1 | NSWO Indicator (see 3GPP TS 33.501 [8]) |
| disasterRoamingInd | boolean | O | 0 . . . 1 | Disaster Roaming Indicator (see 3GPP TS 23.502 [3]). |
| | | | | When present, this IE shall be set as follows: |
| | | | | true: Disaster Roaming service is applied; |
| | | | | false (default): Disaster Roaming service is not |
| | | | | applied. |
| onboardingInd | boolean | O | 0 . . . 1 | Onboarding indicator for the authentication |
| | | | | When present, this IE shall be set as follows: |
| | | | | true: authentication is for onboarding; |
| | | | | false (default): authentication is not for |
| | | | | onboarding. |

NOTE:
The attribute n5gcInd is used for EAP-TLS, which is described in the informative annex O of 3GPP TS 33.501 [8] and is not mandatory to support.

Step 2-a: A new step for AUSF to check the onboarding indicator in the signaling message from AMF. If onboarding is indicated (true) from AMF in the signaling, then AUSF may skip UDM selection, and the steps 3-5 is not executed. If onboarding is not indicated (false or not present) in the signaling, then it may continue to execute steps 3-5.

Step 10-a: A new step for AUSF to check when receiving an EAP success from step which means that the authentication has succeeded, i.e. the UE and the network has mutually authenticated each other through the negotiated EAP authentication method. In step 10, SUPI as UE identity is also returned. Based on the onboarding indication from step 2 signaling message and the SUPI in step 2, AUSF may perform at least one of:
if onboarding is indicated from step 2 signaling message, then skip steps 11-13.
if onboarding is not indicated from step 2 signaling message and SUPI from step 2 is anonymous, then continue to execute steps 11-13.

Step 13-a: A new step on AUSF to check when receiving the response from UDM for the Nudm_UEAU_ResultConfirmation service operation in step 13. Based on the onboarding indication from step 2 signaling message and the response returned from step 13, AUSF may perform at least one of:
if onboarding indicated from step 2 signaling message, then continue to execute branch 1: steps 14-17
if onboarding in not indicated from step 2 signaling message and USER NOT FOUND error returned from step 13, then continue new branch 2: step 15-a, step 16-a, step 17-a (step 14 is skipped so without a corresponding alternative step).

Step 15-a: Although the authentication is a success, but the response code in step 13 indicates that user subscription verification is failed, AUSF shall return a new cause code to AMF, an example one is LACKING_SNPN_SUBSCRIPTION

Step 16-a: AMF may inform the cause of LACKING_SNPN_SUBSCRIPTION to the UE, so that UE is aware of the true cause of the access rejection: lacking SNPN subscription although authentication is succeeded.

Step 17-a: UE shows the user that the true cause of the SNPN access rejection is LACKING_SNPN_SUBSCRIPTION instead of authentication failure (indeed authentication is succeeded), so user could contact the SNPN operator support to fix the problem.

The other steps are same as the corresponding steps of FIG. 1.

In an embodiment, a new step between AMF and AUSF is introduced. When AMF sends the authentication request for the UE, it indicates whether this authentication is for an onboarding or not in the signaling.

In an embodiment, a new step for AUSF is introduced. Based on the above new indication from signaling, AUSF decides whether to query UDM for the authentication method.

In an embodiment, a new step for AUSF is introduced. Based on the above new indication from signaling, AUSF decides whether to verify the SNPN subscription by informing UDM of the authentication result.

In an embodiment, a new step for AUSF is introduced. Based on there is not the new indication from signaling and other information, AUSF decides whether to reject the access to the SNPN by result of the subscription verification from informing UDM of the authentication result.

In an embodiment, AUSF may inform AMF and AMF further to inform the UE the true cause of rejecting the access to the SNPN is lacking SNPN subscription instead of authentication failure (indeed authentication result is a success).

In an embodiment, a new step for UE is introduced to indicate the user that the true cause of SNPN access rejection is for lacking SNPN subscription instead of authentication failures, so the user could contact the SNPN operator supporting service to fix the problem based on the true cause.

Embodiments herein may provide many advantages, of which a non-exhaustive list of examples follows. In some embodiments herein, unnecessary signaling to data management node such as UDM may be avoided if the authentication is for onboarding. This may improve the system performance of both authentication service node AUSF and data management node such as UDM. In some embodiments herein, onboarding service may be handled differently than non-onboarding service, so CSP could monetize their network based on meeting different service requirements. In some embodiments herein, user satisfaction is improved as true cause for SNPN access rejection case could be detected, and user could find the corresponding support correctly. This could help CSP to reduce OPEX and at the same time retain subscriber royalty. The embodiments herein are not limited to the features and advantages mentioned above. A person skilled in the art will recognize additional features and advantages upon reading the following detailed description.

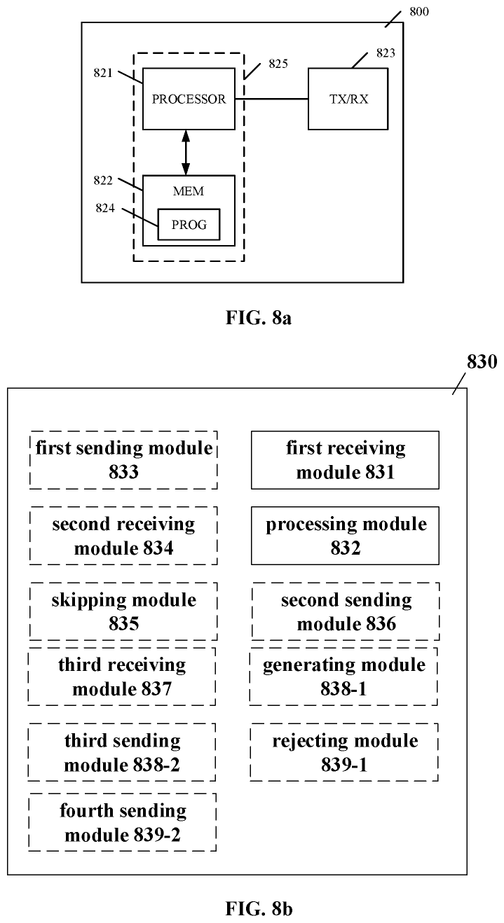

FIG. 8a is a block diagram showing an apparatus suitable for practicing some embodiments of the disclosure. For example, the authentication service node, the access and mobility node, or the terminal device described above may be implemented as or through the apparatus 800.

The apparatus 800 comprises at least one processor 821, such as a digital processor (DP), and at least one memory (MEM) 822 coupled to the processor 821. The apparatus 800 may further comprise a transmitter TX and receiver RX 823 coupled to the processor 821. The MEM 822 stores a program (PROG) 824. The PROG 824 may include instructions that, when executed on the associated processor 821, enable the apparatus 800 to operate in accordance with the embodiments of the present disclosure. A combination of the at least one processor 821 and the at least one MEM 822 may form processing means 825 adapted to implement various embodiments of the present disclosure.

Various embodiments of the present disclosure may be implemented by computer program executable by one or more of the processor 821, software, firmware, hardware or in a combination thereof.

The MEM 822 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 821 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the authentication service node, the memory 822 contains instructions executable by the processor 821, whereby the authentication service node operates according to any of the methods related to the authentication service node as described above.

In an embodiment where the apparatus is implemented as or at the access and mobility node, the memory 822 contains instructions executable by the processor 821, whereby the access and mobility node operates according to any of the methods related to the access and mobility node as described above.

In an embodiment where the apparatus is implemented as or at the terminal device, the memory 822 contains instructions executable by the processor 821, whereby the terminal device operates according to any of the methods related to the terminal device as described above.

FIG. 8b is a block diagram showing an authentication service node according to an embodiment of the disclosure. As shown, the authentication service node 830 comprises a first receiving module 831 configured to receive a first authentication request sent by an access and mobility node. The first authentication request comprises a subscription concealed identifier and first information indicating whether a primary authentication is for a terminal device onboarding. The authentication service node 830 further comprises a processing module 832 configured to process the first authentication request based on the first information.

In an embodiment, the authentication service node 830 further comprises a first sending module 833 configured to send a second authenticate request to a standalone non public network (SNPN) authentication and authorization node.

In an embodiment, the authentication service node 830 further comprises a second receiving module 834 configured to receive a second authenticate response comprising an authentication success, a master session key and a subscription permanent identifier from the SNPN authentication and authorization node.

In an embodiment, the authentication service node 830 further comprises a skipping module 835 configured to, when the first information indicates that the primary authentication is for the terminal device onboarding or the subscription concealed identifier received in the first authentication request is not anonymous, skip sending an authentication result confirmation request to a data management node.

In an embodiment, when the first information indicates that the primary authentication is not for the terminal device onboarding and/or the subscription concealed identifier received in the first authentication request is anonymous, the authentication service node 830 further comprises a second sending module 836 configured to send the authentication result confirmation request to the data management node and a third receiving module 837 configured to receive an authentication result confirmation response from the data management node. The authentication result confirmation request is used for verifying that the subscription permanent identifier corresponds to a valid subscription in the SNPN.

In an embodiment, when the first information indicates that the primary authentication is for the terminal device onboarding or a subscription concealed identifier received in the first authentication request is not anonymous, the authentication service node 830 further comprises a generating module 838-1 configured to generate a key of the authentication service node and a key of security anchor functionality and a third sending module 838-2 configured to send a first authentication response comprising the authentication success, the key of security anchor functionality and the subscription permanent identifier to the access and mobility node.

In an embodiment, when the first information indicates that the primary authentication is not for the terminal device onboarding and/or the subscription concealed identifier received in the first authentication request is anonymous, and when the authentication result confirmation response comprises second information indicating that user subscription verification is failed or a user is not found or it lacks SNPN subscription, the authentication service node 830 further comprises a rejecting module 839-1 configured to reject the terminal device to access the SNPN and a fourth sending module 839-2 configured to send a first authentication response comprising the second information to the access and mobility node.

FIG. 8c is a block diagram showing an access and mobility node according to an embodiment of the disclosure. As shown, the access and mobility node 840 comprises a first receiving module 841 configured to receive a registration request for registering in a standalone non public network (SNPN) from a terminal device. The registration request comprises a subscription concealed identifier. The access and mobility node 840 further comprises a first sending module 842 configured to send a first authentication request to an authentication service node. The first authentication request comprises the subscription concealed identifier and first information indicating whether a primary authentication is for a terminal device onboarding.

In an embodiment, when the first information indicates that the primary authentication is for the terminal device onboarding or the subscription concealed identifier is not anonymous, the access and mobility node 840 further comprises a second receiving module 843 configured to receive a first authentication response comprising an authentication success, a key of security anchor functionality and a subscription permanent identifier from the authentication service node and a second sending module 844 configured to send the authentication success to the terminal device.

In an embodiment, when the first information indicates that the primary authentication is not for the terminal device onboarding and/or the subscription concealed identifier is anonymous, the access and mobility node 840 further comprises a third receiving module 845 configured to receive a first authentication response comprising the second information indicating that user subscription verification is failed or a user is not found or it lacks SNPN subscription from the authentication service node and a third sending module 846 configured to send the second information to the terminal device.

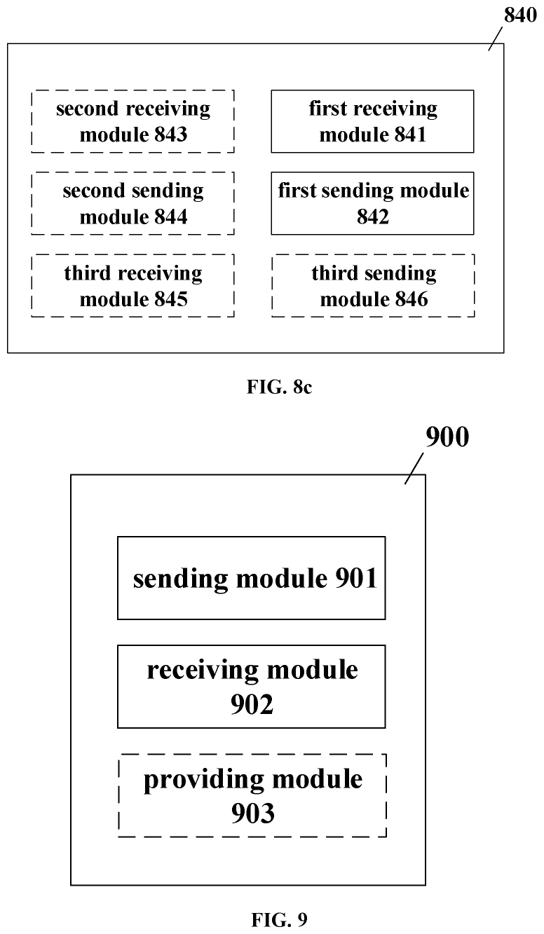

FIG. 9 is a block diagram showing a terminal device according to an embodiment of the disclosure. As shown, the terminal device 900 comprises a sending module 901 configured to send a registration request for registering in a standalone non public network (SNPN) to an access and mobility node. The registration request comprises a subscription concealed identifier. The terminal device 900 further comprises a receiving module 902 configured to receive an authentication success or second information from the access and mobility node. The second information indicates that user subscription verification is failed or a user is not found or it lacks SNPN subscription.

In an embodiment, the terminal device 900 further comprises a providing module 903 configured to provide the second information to a user of the terminal device.

The term unit or module may have conventional meaning in the field of electronics, electrical devices and or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the authentication service node, the access and mobility node, or the terminal device may not need a fixed processor or memory, any computing resource and storage resource may be arranged from the authentication service node, the access and mobility node, or the terminal device in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

Further, the exemplary overall commutation system including the terminal device and the network node will be introduced as below.

Further, the exemplary overall commutation system including the terminal device and the network node (such as the authentication service node and, the access and mobility node described above) will be introduced as below.

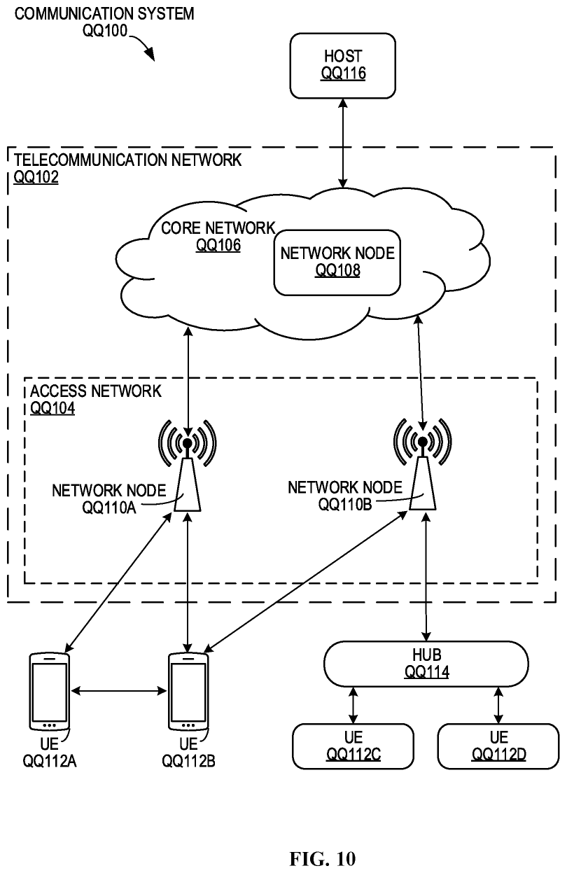

FIG. 10 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and or end point for certain data channels.

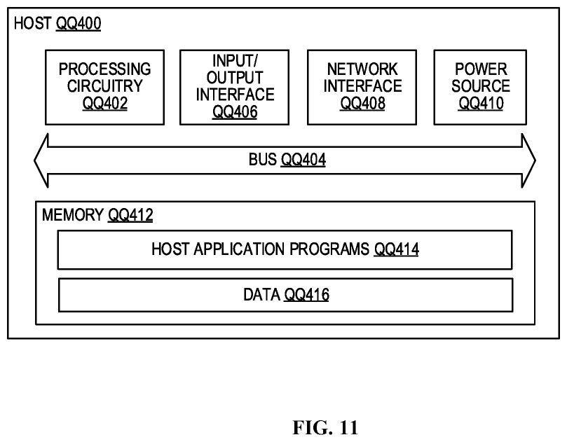

FIG. 11 is a block diagram of a host QQ400, which may be an embodiment of the host QQ116 of FIG. 10, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as Figures QQ2 and QQ3, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

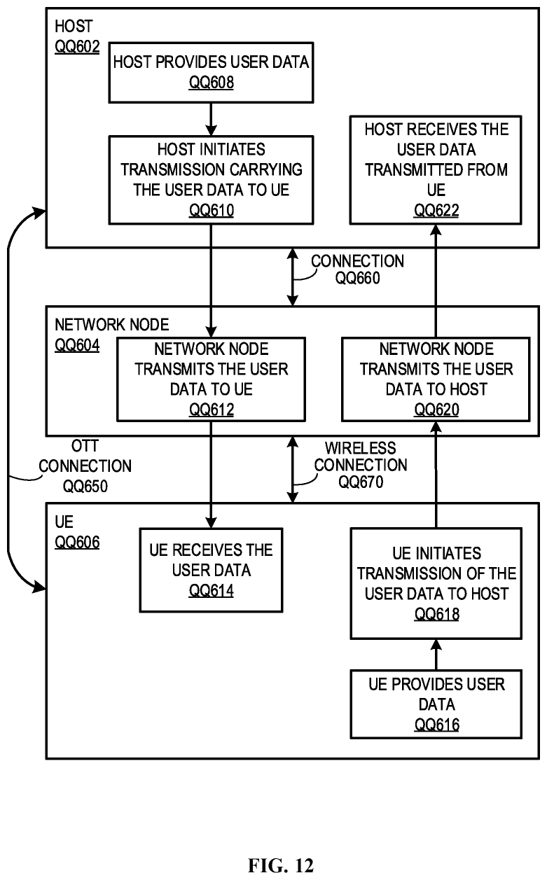

FIG. 12 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 10 and/or UE QQ200 of Figure QQ2), network node (such as network node QQ110a of FIG. 10 and/or network node QQ300 of Figure QQ3), and host (such as host QQ116 of FIG. 10 and/or host QQ400 of FIG. 11) discussed in the preceding paragraphs will now be described with reference to FIG. 12.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 10) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, in some embodiments herein, unnecessary signaling to data management node such as UDM may be avoided if the authentication is for onboarding. This may improve the system performance of both authentication service node AUSF and data management node such as UDM. In some embodiments herein, onboarding service may be handled differently than non-onboarding service, so CSP could monetize their network based on meeting different service requirements. In some embodiments herein, user satisfaction is improved as true cause for SNPN access rejection case could be detected, and user could find the corresponding support correctly. This could help CSP to reduce OPEX and at the same time retain subscriber royalty.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Embodiment 1. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform the operations related to the network node as described above to transmit or facilitate to transmit the user data from the host to the UE.

Embodiment 2. The host of the previous embodiment, wherein:
the processing circuitry of the host is configured to execute a host application that provides the user data; and
the UE comprises processing circuitry configured to execute a client application associated with the host application to receive the transmission of user data from the host.

Embodiment 3. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs the operations related to the network node as described above to transmit or facilitate to transmit the user data from the host to the UE:

Embodiment 4. The method of the previous embodiment, further comprising, at the network node, transmitting the user data provided by the host for the UE.

Embodiment 5. The method of any of the previous 2 embodiments, wherein the user data is provided at the host by executing a host application that interacts with a client application executing on the UE, the client application being associated with the host application.

Embodiment 6. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform the operations related to the network node as described above to transmit or facilitate to transmit the user data from the host to the UE:

Embodiment 7. The communication system of the previous embodiment, further comprising:
the network node; and/or
the user equipment.

Embodiment 8. The communication system of the previous 2 embodiments, wherein:
the processing circuitry of the host is configured to execute a host application, thereby providing the user data; and
the host application is configured to interact with a client application executing on the UE, the client application being associated with the host application.

Embodiment 9. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform the operations related to the network node as described above to receive or facilitate to receive the user data from the UE for the host:

Embodiment 10. The host of the previous 2 embodiments, wherein:
the processing circuitry of the host is configured to execute a host application, thereby providing the user data; and
the host application is configured to interact with a client application executing on the UE, the client application being associated with the host application.

Embodiment 11. The host of the any of the previous 2 embodiments, wherein the initiating receipt of the user data comprises requesting the user data.

Embodiment 12. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs the operations related to the network node as described above to receive or facilitate to receive the user data from the UE for the host:

Embodiment 13. The method of the previous embodiment, further comprising at the network node, transmitting the received user data to the host.

Embodiment 14. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform the operations related to the terminal device as described above to receive or facilitate to receive the user data from the host:

Embodiment 15. The host of the previous embodiment, wherein the cellular network further includes a network node configured to communicate with the UE to transmit the user data to the UE from the host.

Embodiment 16. The host of the previous 2 embodiments, wherein:
the processing circuitry of the host is configured to execute a host application, thereby providing the user data; and
the host application is configured to interact with a client application executing on the UE, the client application being associated with the host application.

Embodiment 17. A method implemented by a host operating in a communication system that further includes a network node and a user equipment (UE), the method comprising:
providing user data for the UE; and
initiating a transmission carrying the user data to the UE via a cellular network comprising the network node, wherein the UE performs the operations related to the terminal device as described above to receive or facilitate to receive the user data from the host:

Embodiment 18. The method of the previous embodiment, further comprising:
at the host, executing a host application associated with a client application executing on the UE to receive the user data from the UE.

Embodiment 19. The method of the previous embodiment, further comprising:
at the host, transmitting input data to the client application executing on the UE, the input data being provided by executing the host application,
wherein the user data is provided by the client application in response to the input data from the host application.

Embodiment 20. A host configured to operate in a communication system to provide an over-the-top (OTT) service, the host comprising:
processing circuitry configured to utilize user data; and
a network interface configured to receipt of transmission of the user data to a cellular network for transmission to a user equipment (UE),
wherein the UE comprises a communication interface and processing circuitry, the communication interface and processing circuitry of the UE being configured to perform the operations related to the terminal device as described above to transmit or facilitate to transmit the user data to the host:

Embodiment 21. The host of the previous embodiment, wherein the cellular network further includes a network node configured to communicate with the UE to transmit the user data from the UE to the host.

Embodiment 22. The host of the previous 2 embodiments, wherein:
the processing circuitry of the host is configured to execute a host application, thereby providing the user data; and
the host application is configured to interact with a client application executing on the UE, the client application being associated with the host application.

Embodiment 23. A method implemented by a host configured to operate in a communication system that further includes a network node and a user equipment (UE), the method comprising:
at the host, receiving user data transmitted to the host via the network node by the UE, wherein the UE performs the operations related to the terminal device as described above to transmit or facilitate to transmit the user data to the host:

Embodiment 24. The method of the previous embodiment, further comprising:
at the host, executing a host application associated with a client application executing on the UE to receive the user data from the UE.

Embodiment 25. The method of the previous embodiments, further comprising:
at the host, transmitting input data to the client application executing on the UE, the input data being provided by executing the host application,
wherein the user data is provided by the client application in response to the input data from the host application.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method performed by an authentication service node, comprising:
receiving a first authentication request sent by an access and mobility node, wherein the first authentication request comprises a subscription concealed identifier and first information indicating whether a primary authentication is for a terminal device onboarding; and
processing the first authentication request based on the first information.

2. The method of claim 1, wherein the first information is an indicator.

3. The method of claim 2, wherein
when the indicator is set to true, it indicates that the primary authentication is for the terminal device onboarding, and
when the indicator is set to false or the indicator is not present, it indicates that the primary authentication is not for the terminal device onboarding.

4. The method of claim 1, wherein processing the first authentication request based on the first information comprises:
when the first information indicates that the primary authentication is for the terminal device onboarding, skipping a selection of a data management node and skipping sending a request for authentication method selection to the data management node; or
when the first information indicates that the primary authentication is not for the terminal device onboarding, selecting the data management node and sending the request for authentication method selection to the data management node.

5. The method of claim 1, further comprising:
sending a second authenticate request to a standalone non public network (SNPN) authentication and authorization node; and
receiving a second authenticate response comprising an authentication success, a master session key and a subscription permanent identifier from the SNPN authentication and authorization node, wherein the method further comprises:
when the first information indicates that the primary authentication is for the terminal device onboarding or the subscription concealed identifier received in the first authentication request is not anonymous, skipping sending an authentication result confirmation request to a data management node, or
when the first information indicates that the primary authentication is not for the terminal device onboarding and/or the subscription concealed identifier received in the first authentication request is anonymous, sending the authentication result confirmation request to the data management node and receiving an authentication result confirmation response from the data management node, wherein the authentication result confirmation request is used for verifying that the subscription permanent identifier corresponds to a valid subscription in the SNPN.

6. The method of claim 5, wherein when the first information indicates that the primary authentication is for the terminal device onboarding or a subscription concealed identifier received in the first authentication request is not anonymous, the method further comprises:
generating a key of the authentication service node and a key of security anchor functionality; and
sending a first authentication response comprising the authentication success, the key of security anchor functionality and the subscription permanent identifier to the access and mobility node.

7. The method of claim 5, wherein when the first information indicates that the primary authentication is not for the terminal device onboarding and/or the subscription concealed identifier received in the first authentication request is anonymous, the method further comprises:
when the authentication result confirmation response comprises second information indicating that user subscription verification is failed or a user is not found or it lacks SNPN subscription, rejecting the terminal device to access the SNPN and sending a first authentication response comprising the second information to the access and mobility node.

8. The method of claim 5, wherein the SNPN authentication and authorization node comprises a network slice specific and SNPN authentication and authorization function (NSSAAF).

9. The method of claim 4, wherein the data management node comprises a unified data management (UDM).

10. The method of claim 1, wherein
the access and mobility node comprises an access and mobility management function (AMF), and/or
the authentication service node comprises an authentication server function (AUSF).

11. (canceled)

12. A method performed by an access and mobility node, comprising:
receiving a registration request for registering in a standalone non public network from a terminal device, wherein the registration request comprises a subscription concealed identifier; and
sending a first authentication request to an authentication service node, wherein the first authentication request comprises the subscription concealed identifier and first information indicating whether a primary authentication is for a terminal device onboarding.

13. The method of claim 12, wherein the first information is an indicator.

14. The method of claim 13, wherein
when the indicator is set to true, it indicates that the primary authentication is for the terminal device onboarding, and
when the indicator is set to false or the indicator is not present, it indicates that the primary authentication is not for the terminal device onboarding.

15. The method of claim 12, wherein when the first information indicates that the primary authentication is for the terminal device onboarding or the subscription concealed identifier is not anonymous, the method further comprises:
receiving a first authentication response comprising an authentication success, a key of security anchor functionality and a subscription permanent identifier from the authentication service node; and
sending the authentication success to the terminal device.

16. The method of claim 12, wherein when the first information indicates that the primary authentication is not for the terminal device onboarding and/or the subscription concealed identifier is anonymous, the method further comprises:
receiving a first authentication response comprising the second information indicating that user subscription verification is failed or a user is not found or it lacks SNPN subscription from the authentication service node; and
sending the second information to the terminal device.

17. The method of claim 12, wherein the access and mobility node comprises an access and mobility management function (AMF).

18. The method of claim 12, wherein the authentication service node comprises an authentication server function (AUSF).

19. A method performed by a terminal device, comprising:
sending a registration request for registering in a standalone non public network to an access and mobility node, wherein the registration request comprises a subscription concealed identifier; and
receiving an authentication success or second information from the access and mobility node, wherein the second information indicates that user subscription verification is failed or a user is not found or it lacks SNPN subscription.

20. The method of claim 19, wherein the access and mobility node comprises an access and mobility management function (AMF).

21. The method of claim 19, further comprising:
providing the second information to a user of the terminal device.

22-29. (canceled)
